(19) United States
(12) Patent Application Publication
(10) Pub. No.: US 2012/0068694 A1
(43) Pub. Date: Mar. 22, 2012

(54) METHOD OF DETECTING ABSOLUTE ROTATIONAL POSITION

(75) Inventors: Muneo Mitamura, Nagano (JP); Kunio Miyashita, Nagano (JP); Junji Koyama, Nagano (JP)

(73) Assignee: HARMONIC DRIVE SYSTEMS INC., Shinagawa-ku (JP)

(21) Appl. No.: 12/596,006

(22) PCT Filed: Apr. 24, 2007
(86) PCT No.: PCT/JP2007/000448

§ 371 Date: Jun. 30, 2010

(51) Int. Cl. G01B 7/30

(52) U.S. Cl. 324/207.25

(57) ABSTRACT

Before detecting a mechanical angular absolute position θabs of a rotating shaft (4) within one turn using a two-pole absolute value encoder (2) and a multi-pole absolute value encoder (3) having Pp (Pp: an integer of 3 or more) pole pairs, the rotating shaft (4) is rotated to measure a temporary absolute value θelt of the multi-pole absolute value encoder (3) in relation to each absolute value θt of the two-pole absolute value encoder (2), and a temporary pole-pair number (Nx) for a multi-pole magnet is assigned to each absolute value θt. In actual detecting, an absolute value θti of the two-pole absolute value encoder and an absolute value θelr of the multi-pole absolute value encoder are measured, the temporary pole-pair number (Nx) assigned to the absolute value θti is corrected on the basis of an absolute value θelti of the multi-pole absolute value encoder assigned to the absolute value θti and the measured absolute value θelr, thus calculating a pole-pair number (Nr). The absolute position θabs is calculated using an expression of (Nr×θelp+θelr)/Pp with a mechanical angle θelp corresponding to an electrical angle of one period of an output signal of the multi-pole absolute value encoder.

### TECHNICAL FIELD

The present invention relates to a method of magnetically detecting an absolute rotational position and to a magnetic absolute-value encoder that are capable of using two magnetic encoders to precisely detect the absolute position of a rotating shaft within one rotation.

### BACKGROUND ART

Magnetic absolute-value encoders in which two magnetic encoders are used to precisely detect the absolute position of a rotating shaft are well-known. In the configuration disclosed in Patent Document 1, a 12-bit absolute value output having 4096 partitions (64×64) is obtained using a two-pole magnetic encoder and a 64-pole magnetic encoder. In this magnetic encoder, 6 upper bits are generated by the two-pole magnetic encoder, and 6 lower bits are generated by the 64-pole magnetic encoder.
[Patent Document 1] Japanese Unexamined Utility Model Application No. 06-10813

However, in a magnetic encoder having this configuration, the precision of the two-pole magnetic encoder must be equivalent to the 6 bits of the 64-pole magnetic encoder. The precision of the two-pole magnetic encoder must therefore be further increased in order to obtain output having higher precision, and increasing precision is therefore difficult. The start points of the output signal of the two-pole magnetic encoder and the output signal of the 64-pole magnetic encoder must be aligned, and problems are presented in that time is required to make such adjustments.

### DISCLOSURE OF THE INVENTION

In light of these problems, it is an object of the present invention to propose a method of detecting absolute rotational position that is capable of detecting an absolute value having high precision without being affected by the precision and resolution of a two-pole magnetic encoder when detecting the absolute position of a rotating shaft using a two-pole magnetic encoder and a multi-pole magnetic encoder.

In order to solve the aforementioned problems, according to the present invention, there is provided a method of detecting absolute rotational position using a two-pole absolute-value encoder and a multi-pole absolute-value encoder to detect absolute rotational positions of a rotating shaft within one rotation, the multi-pole absolute-value encoder having Pp pairs of magnetic poles (where Pp is an integer of 2 or greater). The method of detecting absolute rotational position is characterized in comprising the two-pole absolute-value encoder having a bipolarly magnetized two-pole magnet rotating integrally with the rotating shaft, and also having a pair of magnetic detecting elements whereby sinusoidal signals having a phase difference of 90° are output as one wave period per rotation of the rotating shaft in accompaniment with the rotation of the two-pole magnet; and the multi-pole absolute-value encoder having a multi-pole magnet magnetized so as to have Pp pairs of magnetic poles, the multi-pole magnet rotating integrally with the rotating shaft, and also having a pair of magnetic detecting elements whereby sinusoidal signals having a phase difference of 90° are output as Pp wave periods per rotation of the rotating shaft in accompaniment with the rotation of the multi-pole magnet; wherein, in advance of an operation for detecting the rotational position of the rotating shaft, the rotating shaft is caused to rotate, absolute values θelt of the multi-pole absolute-value encoder are measured and assigned to respective absolute values θt of the two-pole absolute-value encoder, and temporary pole-pair numbers Nx of the multi-pole magnet are assigned to the respective absolute values θt of the two-pole absolute-value encoder; and wherein, when detection of the rotational position of the rotating shaft is started, an absolute value θti of the rotating shaft according to the two-pole absolute-value encoder is measured; the absolute value θelr of the rotating shaft according to the multi-pole absolute-value encoder is measured; the temporary pole-pair number Nx assigned to the absolute value θti is corrected and a pole-pair number Nr is calculated on the basis of the absolute value θelt assigned to the measured absolute value θti and on the basis of the measured absolute value θelr; and a mechanical angular absolute position θabs of the rotating shaft within one rotation is calculated according to the following equation using a mechanical angle θelp that corresponds to an electrical angle of one period of an output signal of the multi-pole absolute-value encoder.

θabs=(Nr×θelp+θelr)/Pp

An accurate pole-pair number Nr can be determined from the temporary pole-pair number Nx as below when the precision or angular reproducibility X of the two-pole absolute-value encoder satisfies the following equation, where Rt is a resolution of the two-pole absolute-value encoder.

X<2×((θelp/2)−(Pp×θelp/Rt))/Pp

Specifically, when θelt≧θelp/2, the corrected pole-pair number Nr is set to Nx if θelr≧(θelt−θelp/2), and the corrected pole-pair number Nr is set to Nx+1 if θelr<(θelt−θelp/2).

Conversely, when θelt<θelp/2, the corrected pole-pair number Nr is set to Nx if θelr<(θelt+θelp/2), and the corrected pole-pair number Nr is set to Nx−1 if θelr≧(θelt+θelp/2).

The angular reproducibility X of the two-pole absolute-value encoder may be set so as to satisfy the following equation, where Rtmin is the minimum value of the resolution of the two-pole absolute-value encoder for each of the magnetic pole pairs of the multi-pole absolute-value encoder.

X<2×((θelp/2)−(θelp/Rtmin))/Pp

Generally, an accurate pole-pair number Nr can be determined from the temporary pole-pair number Nx as below when the precision or angular reproducibility X of the two-pole absolute-value encoder satisfies the following equation, where M is an integer of 2 or greater.

X<2×((θelp/M)−(Pp×θelp/Rt))/Pp

When θelt≧θelp/M, the corrected pole-pair number Nr is set to Nx if θelr≧(θelt−θelp/M), and the corrected pole-pair number Nr is set to Nx+1 if θelr<(θelt−θelp/M).

When θelt<θelp/2, the corrected pole-pair number Nr is set to Nx if θelr<(θelt+θelp/M), and the corrected pole-pair number Nr is set to Nx−1 if θelr≧(θelt+θelp/M).

The angular reproducibility X of the two-pole absolute-value encoder may be set so as to satisfy the following equation, where Rtmin is the minimum value of the resolution of the two-pole absolute-value encoder for each of the magnetic pole pairs of the multi-pole absolute-value encoder.

X<2×((θelp/M−(θelp/Rtmin))/Pp

According to the method of detecting absolute rotational position of the present invention, the resolution for detecting the absolute position of the rotating shaft is prescribed by Pp×Rm, where Rm is the resolution of the multi-pole absolute-value encoder. Detection precision is dependent solely on the resolution of the multi-pole absolute-value encoder. The resolution and precision of the two-pole absolute-value encoder have no relation to the resolution and precision of detection of the absolute position and are employed only to obtain the pole-pair number. A magnetic absolute-value encoder having high resolution can therefore be implemented according to the present invention without increasing the resolution and precision of the two-pole absolute-value encoder.

### BRIEF DESCRIPTION OF THE DRAWINGS

FIG. 1 is a schematic structural diagram of a magnetic absolute-value encoder in which the present invention is applied;

FIG. 2 is a waveform diagram that shows the output waveform of the two-pole absolute-value encoder and the multi-pole absolute-value encoder of FIG. 1, and a descriptive diagram that shows a state in which a portion [of the waveform diagram] (*2) is extended in the direction of the time axis;

FIG. 3 is a flow chart that shows a process flow for calculating the mechanical angular absolute position;

FIG. 4 is a descriptive diagram that shows the process operation from step ST13 to step ST19 in FIG. 3;

FIG. 5 is a descriptive diagram that shows the process operation from step ST13 to step ST21 in FIG. 3; and

FIG. 6 is a flow chart that shows a process flow for calculating the mechanical angular absolute position.

### BEST MODE FOR CARRYING OUT THE INVENTION

Embodiments of a magnetic absolute-value encoder in which the present invention is applied will be described below with reference to the drawings.

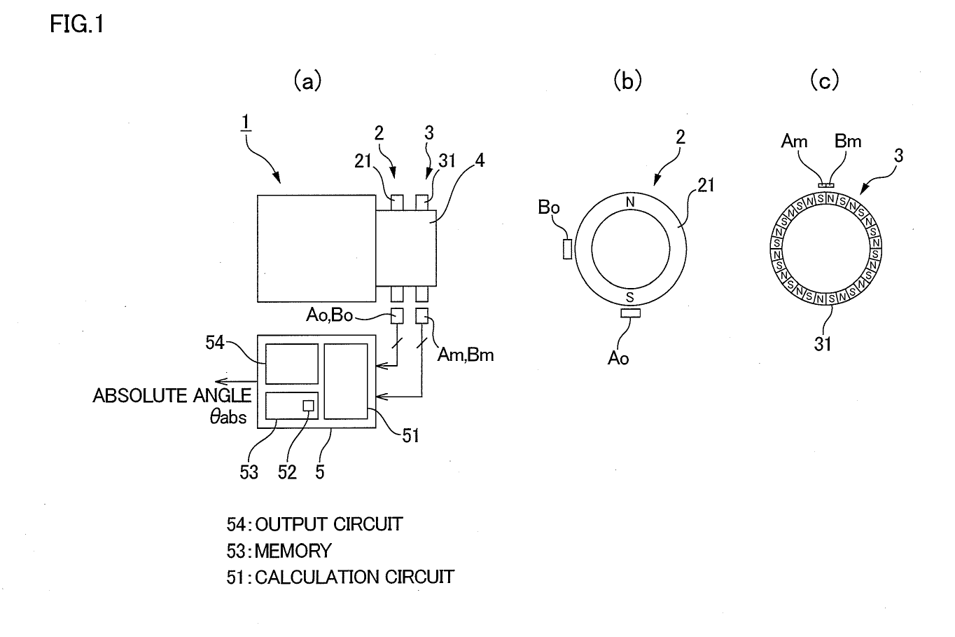

FIG. 1 is a schematic block diagram showing a magnetic absolute-value encoder for detecting the absolute rotational position of a rotating shaft within one rotation using the method of detecting absolute position according to the present invention. A magnetic absolute-value encoder 1 has a two-pole absolute-value encoder 2, a multi-pole absolute-value encoder 3 having Pp pairs of magnetic poles (where Pp is an integer of 2 or greater), and a control part 5 for calculating the absolute rotational position within one rotation of a rotating shaft 4 to be measured on the basis of the detection output of the absolute-value encoders 2, 3.

The two-pole absolute-value encoder 2 is provided with a two-pole magnet ring 21 that is magnetized on two poles and that rotates integrally with the rotating shaft 4, and a pair of magnetic detecting elements; e.g., Hall elements Ao, Bo for outputting sinusoidal signals according to the rotation of the two-pole magnet ring 21, the sinusoidal signals having a phase difference of 90°, and a single wave period corresponding to one rotation of the rotating shaft.

The multi-pole absolute-value encoder 3 is provided with a multi-pole magnet ring 31 that is magnetized so as to have Pp pairs of poles and that rotates integrally with the rotating shaft 4, and a pair of magnetic detecting elements, e.g., Hall elements Am, Bm for outputting sinusoidal signals according to the rotation of the multi-pole magnet ring 31, the sinusoidal signals having a phase difference of 90°, and Pp wave periods corresponding to one rotation of the rotating shaft.

The control part 5 is provided with a calculation circuit 51, a non-volatile memory 53 in which a correspondence table 52 is maintained, and an output circuit 54 for outputting a calculated absolute rotational position θabs to a higher-order drive-control device (not shown).

A resolution Rt, i.e., an absolute position θt of the mechanical angle from 0 to 360°, is calculated in the calculation circuit 51 of the control part 5 from the sinusoidal signals having a phase difference of 90° output from the pair of the Hall elements Ao, Bo of the two-pole absolute-value encoder 2. A resolution Rm, i.e. an absolute position θelr of the electrical angle from 0 to 360° (mechanical angle 0 to 360°/Pp), is calculated in the calculation circuit 51 from the sinusoidal signals having a phase difference of 90° output from the pair of the Hall elements Am, Bm of the multi-pole absolute-value encoder 3. The mechanical angular absolute position θabs within one rotation of the rotating shaft 4 is calculated according to the following equation using θelp (=360°/Pp) and a pole-pair number Nr, which is calculated as described hereinafter.

θabs=(Nr×θelp+θelr)/Pp (1)

In order to accurately calculate the pole-pair number Nr, the precision or angular reproducibility X of the two-pole absolute-value encoder 2 is set so as to satisfy the following equation.

X<2×((θelp/2−(Pp×θelp/Rt))/Pp (2)

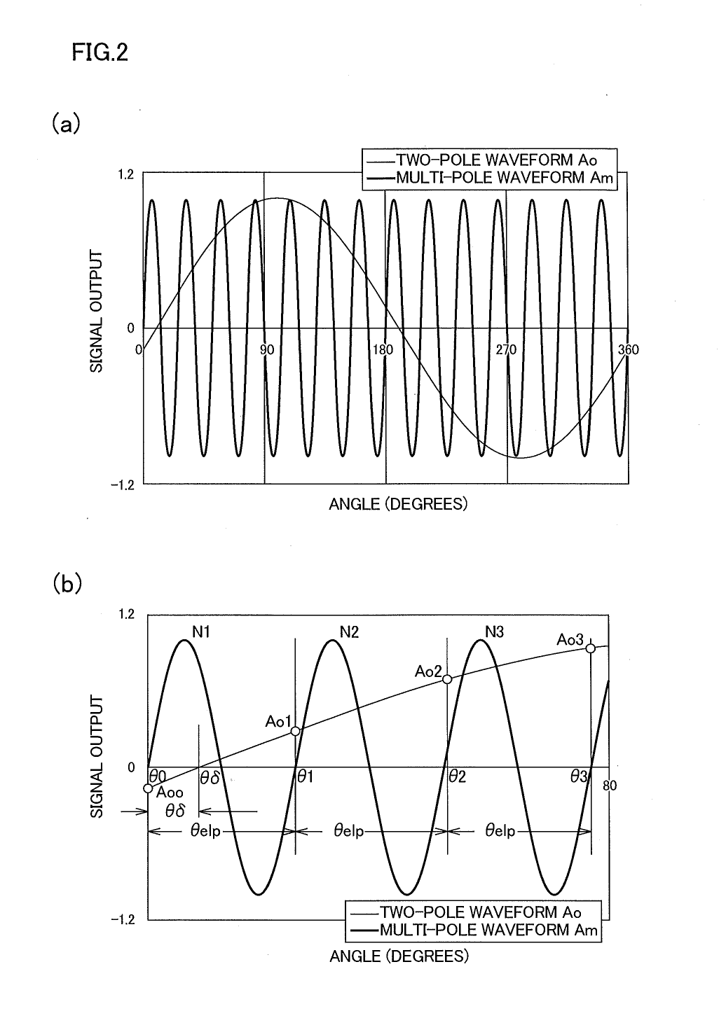

In FIG. 2(a), the two-pole waveform output from the Hall element Ao is shown by the thin line, and the multi-pole waveform output from the Hall element Am is shown by the thick line. FIG. 2(b) shows a portion thereof enlarged in the direction of the horizontal axis (time axis).

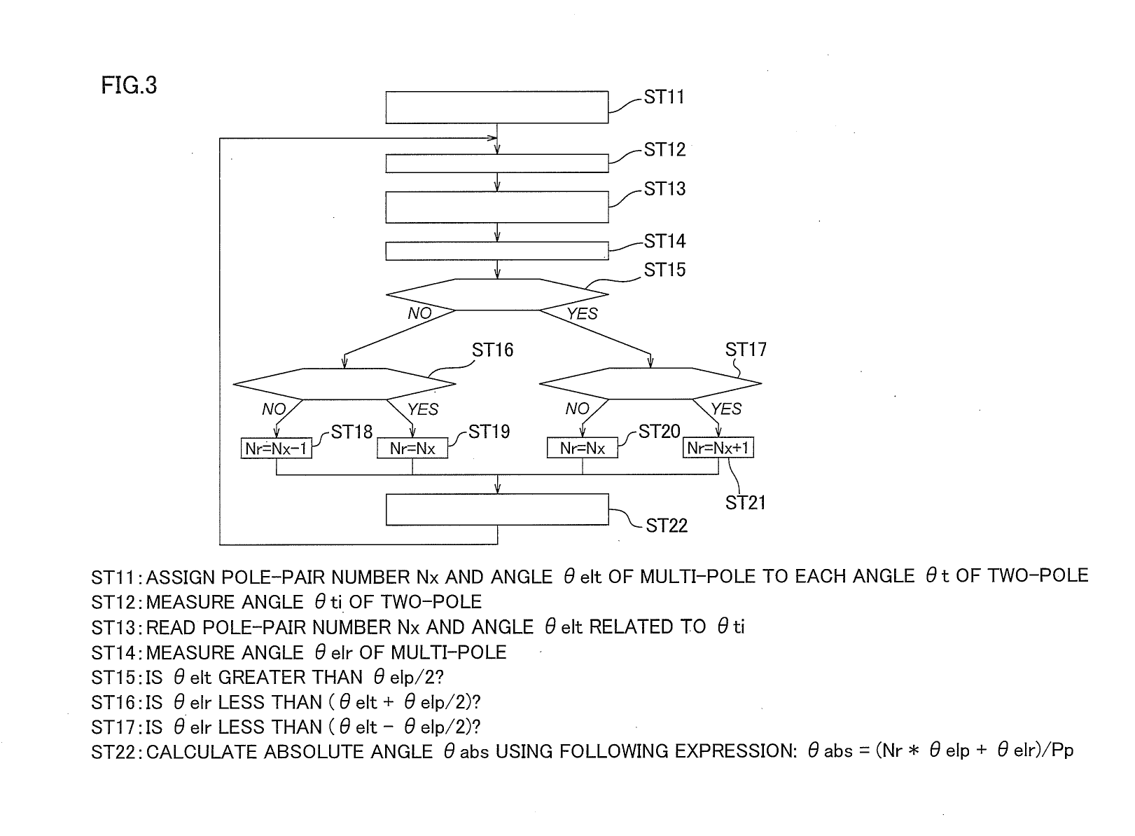

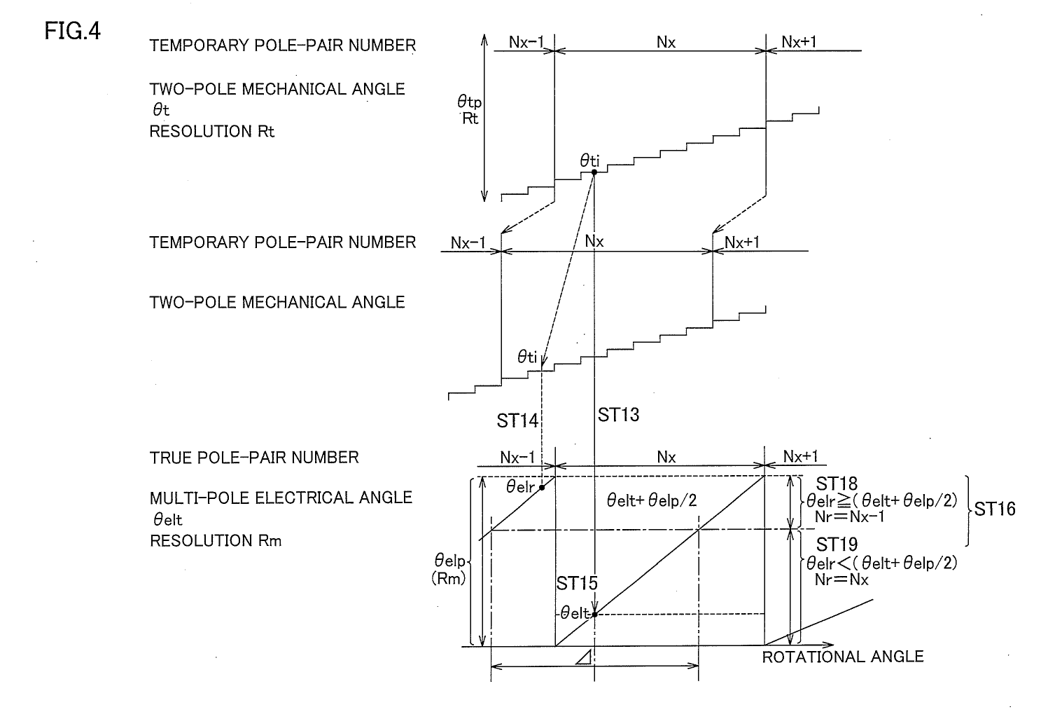

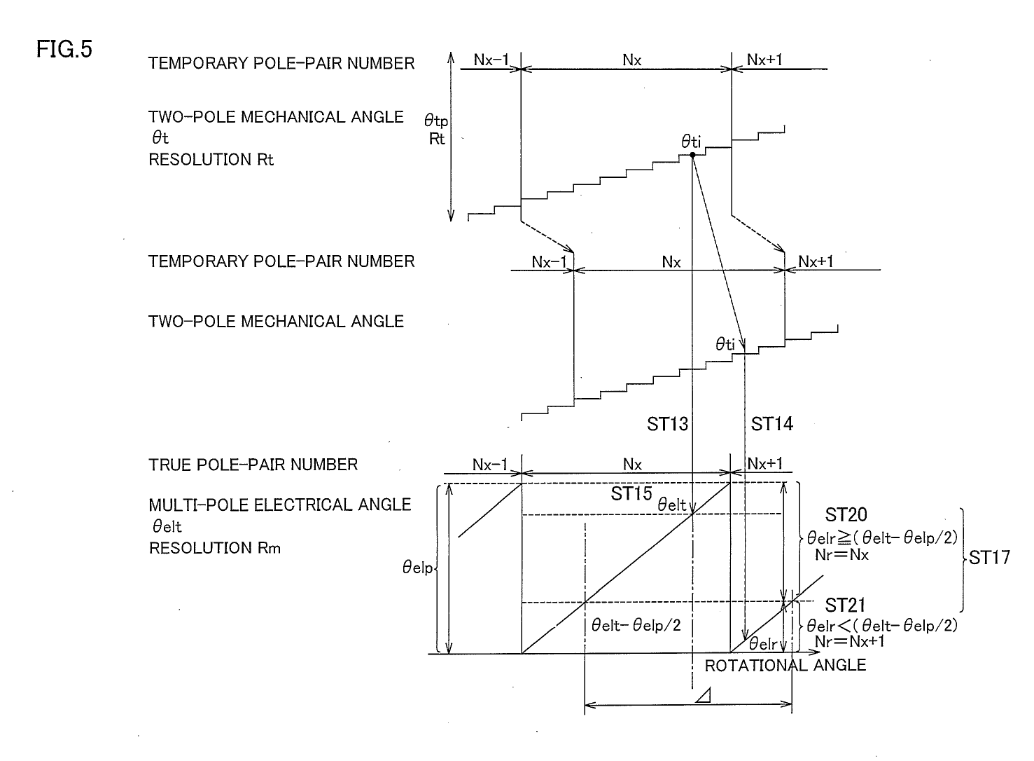

FIG. 3 is a flow chart showing the procedure for calculating the pole-pair number Nr. FIGS. 4 and 5 are descriptive diagrams showing the Nr calculation operation. The meanings of the symbols are listed below.

Rm: Resolution of the multi-pole absolute-value encoder
Rt: Resolution of the two-pole absolute-value encoder
θelr: Actual absolute value of the multi-pole absolute-value encoder (0 to (θelp−1))
θelt: Temporary absolute value of the multi-pole absolute-value encoder (0 to (θelp−1))
θti: Absolute value of the two-pole absolute-value encoder (0 to (θtp−1))
Pp: Number of pairs of magnetic poles of the multi-pole magnet ring
Nr: Actual pole-pair number of the multi-pole magnet ring (0 to (Pp−1))
Nx: Temporary pole-pair number of the multi-pole magnet ring (0 to (Pp−1))

Before the actual detection operation in the magnetic absolute-value encoder 1, the rotating shaft 4 is rotationally driven at a constant temperature, rotational runout, and speed, and the outputs of the two-pole absolute-value encoder 2 and the multi-pole absolute-value encoder 3 are measured. In other words, the temporary absolute value θelt of the multi-pole absolute-value encoder 3 is measured relative to the absolute value θti of the two-pole absolute-value encoder 2. A temporary pole-pair number Nx of the multi-pole magnet ring 31 is then assigned to each of the absolute values θti of the two-pole absolute-value encoder 2. This information is made into the correspondence table 52 and is stored and maintained in the non-volatile memory 53 (step ST11 in FIG. 3).

The absolute value θti of the rotating shaft 4 according to the two-pole absolute-value encoder 2 is measured at the outset of the actual detection operation (step ST12 in FIG. 3). The absolute value θti is used to consult the correspondence table 52, and the temporary absolute value θelt of the multi-pole absolute-value encoder 3 and the temporary pole-pair number Nx of the multi-pole magnet ring 31 assigned to the absolute value θti are read (step ST13 of FIG. 3). The absolute value θelr of the rotating shaft 4 according to the multi-pole absolute-value encoder 3 is measured simultaneously with or subsequent to this operation (step ST14 of FIG. 3).

The absolute value θti of the two-pole absolute-value encoder 2 corresponding to the actual absolute value θelr changes depending on temperature, rotational runout, speed, and other operational conditions, and the relationship is not constant. The absolute value θti and the absolute value θelt that are assigned as corresponding in the correspondence table 52 therefore frequently do not correspond in actual rotational states. In other words, the correspondence fluctuates within the range of the angular reproducibility X prescribed by Equation (2).

Accordingly, the temporary pole-pair number Nx is corrected, and the accurate pole-pair number Nr is calculated as follows.

First, a determination is made as to whether the absolute value θelt that has been temporarily assigned is equal to or greater than the value help/2 (step ST15 in FIG. 3).

When θelt<θelp/2, a determination is made as to whether the measured absolute value θelr is smaller than (θelt+θelp/2) (step ST16 in FIG. 3). The pole-pair number Nr is set on the basis of the results of this determination, as follows.

The pole-pair number Nr is set to Nx if θelr<(θelt+θelp/2) (step ST19 in FIG. 3). Conversely, the pole-pair number Nr is set to Nx−1 if θelr≧(θelt+θelp/2) (step ST18 in FIG. 3).

The procedure for the process from step ST13 to steps ST18, 19 of FIG. 3 is shown in FIG. 4. As shown in the drawings, when the absolute value of the two-pole absolute-value encoder 2 is θti, the absolute value θelr of the multi-pole absolute-value encoder 3 fluctuates at a fluctuation amplitude Δ due to the axial runout of the rotating shaft 4 or other rotational conditions. When the deviation in the amount of rotation of the rotating shaft 4 is small, the actual rotational position of the rotating shaft 4 will be within the angular range to which the pole-pair number Nx−1 has been assigned. The actual absolute value θelr is larger than (θelt+θelp/2) in this case, on which basis the actual pole-pair number Nr can accordingly be determined to be Nx−1.

On the other hand, when θelt≧θelp/2, a determination is made as to whether the measured absolute value θelr is less than (θelt−θelp/2) (step ST17 in FIG. 3). The pole-pair number Nr is designated as follows on the basis of the results of this determination.

The pole-pair number Nr is set to Nx if θelr≧(θelt−θelp/2) (step ST20 in FIG. 3). Conversely, the pole-pair number Nr is set to Nx+1 if θelr<(θelt−θelp/2) (step ST21 in FIG. 3).

The procedure for the process from step ST13 to steps ST20, 21 of FIG. 3 is shown in FIG. 5. As shown in the drawings, when the absolute value of the two-pole absolute-value encoder 2 is θti, the absolute value θelr of the multi-pole absolute-value encoder 3 fluctuates at a fluctuation amplitude Δ due to the axial runout of the rotating shaft 4 or other rotational conditions. When the deviation in the amount of rotation of the rotating shaft 4 is large, the actual rotational position of the rotating shaft 4 will be within the angular range to which the pole-pair number Nx+1 has been assigned. The actual absolute value θelr is smaller than (θelt−θelp/2) in this case, on which basis the actual pole-pair number Nr can accordingly be determined to be Nx+1.

The pole-pair number Nr is thus calculated, and the mechanical absolute angular position θabs of the rotating shaft 4 is calculated on the basis of Equation (1) above. The mechanical absolute angular position θabs of the rotating shaft 4 can be continually detected thereafter based on the changes of the absolute value θelr of the multi-pole absolute-value encoder 3.

If the magnetic absolute-value encoder 1 of the present example is used as described above, the resolution and precision of detection are prescribed by the multi-pole absolute-value encoder 3, and the resolution and precision of detection are not limited by the resolution and precision of the two-pole absolute-value encoder 2. An adjustment for matching the start points of the detection signals of the two-pole absolute-value encoder 2 and the multi-pole absolute-value encoder 3 is also unnecessary.

Variation may be present in a size Rti of the resolution of the two-pole absolute-value encoder 2 for each of the magnetic pole pairs of the multi-pole absolute-value encoder 3. The sum of the resolutions Rti of the two-pole absolute-value encoder 2 corresponding to each of the magnetic pole pairs may be Rt. When the minimum value of the resolutions Rti is Rtmin, the precision or angular reproducibility X of the two-pole absolute-value encoder 2 may be set as in the following equation in order to accurately calculate the pole-pair number Nr.

X<2×((θelp/2−(θelp/Rtmin))/Pp (2A)

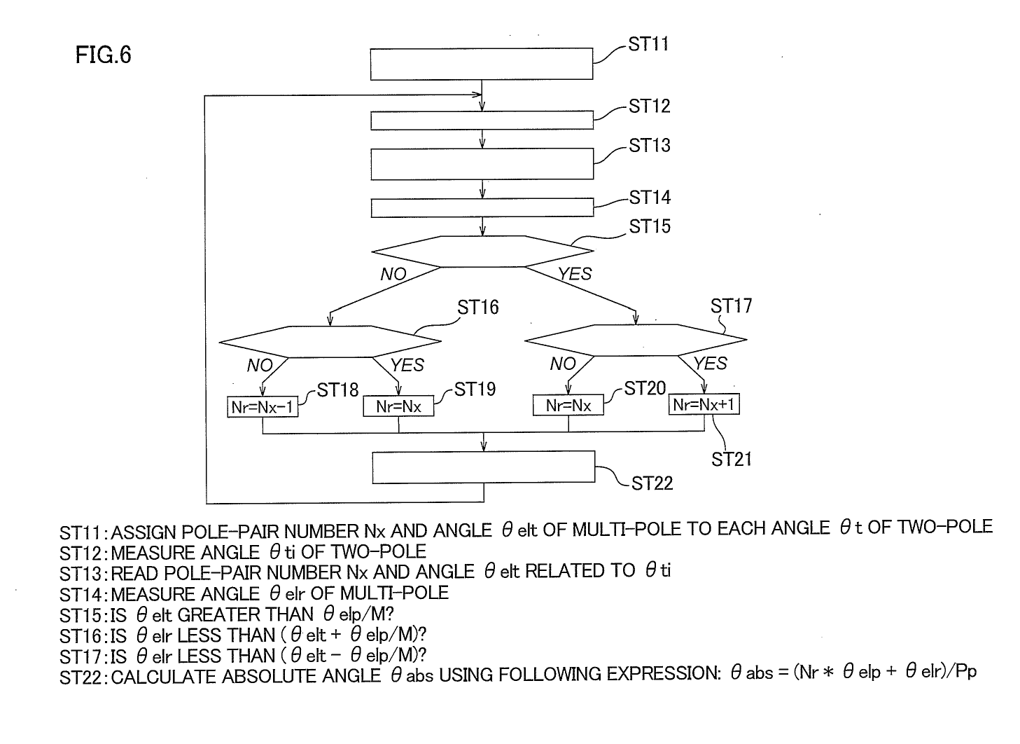

In general, in the method according to the present invention, if the precision or angular reproducibility X of the two-pole absolute-value encoder 2 is set so as to satisfy the following equation, where M is an integer of 2 or greater, the mechanical angular absolute position Gabs can be calculated according to the flow shown in FIG. 6.

X<2×((θelp/M−(Pp×θelp/Rt))/Pp (2B)

In this case as well, when the minimum value of the size Rti of the resolution of the two-pole absolute-value encoder 2 for each of the magnetic pole pairs of the multi-pole absolute-value encoder 3 is Rtmin, the precision or angular reproducibility X of the two-pole absolute-value encoder 2 may be set so as to satisfy the following equation in order to accurately calculate the pole-pair number Nr.

X<2×((θelp/M−(θelp/Rtmin))/Pp (2C)

1. A method of detecting absolute rotational position using a two-pole absolute-value encoder and a multi-pole absolute-value encoder to detect absolute rotational positions of a rotating shaft within one rotation, the multi-pole absolute-value encoder having Pp pairs of magnetic poles (where Pp is an integer of 2 or greater); comprising:
the two-pole absolute-value encoder having a bipolarly magnetized two-pole magnet rotating integrally with the rotating shaft, and also having a pair of magnetic detecting elements whereby sinusoidal signals having a phase difference of 90° are output as one wave period per rotation of the rotating shaft in accompaniment with the rotation of the two-pole magnet; and
the multi-pole absolute-value encoder having a multi-pole magnet magnetized so as to have Pp pairs of magnetic poles, the multi-pole magnet rotating integrally with the rotating shaft, and also having a pair of magnetic detecting elements whereby sinusoidal signals having a phase difference of 90° are output as Pp wave periods per rotation of the rotating shaft in accompaniment with the rotation of the multi-pole magnet;
wherein, in advance of an operation for detecting the rotational position of the rotating shaft, the rotating shaft is caused to rotate, absolute values Belt of the multi-pole absolute-value encoder are measured and assigned to respective absolute values θt of the two-pole absolute-value encoder, and temporary pole-pair numbers Nx of the multi-pole magnet are assigned to the respective absolute values θt of the two-pole absolute-value encoder; and
wherein, when detection of the rotational position of the rotating shaft is started, the absolute value θti of the rotating shaft according to the two-pole absolute-value encoder is measured;
the absolute value θelr of the rotating shaft according to the multi-pole absolute-value encoder is measured;
the temporary pole-pair number Nx assigned to the absolute value θti is corrected and a pole-pair number Nr is calculated on the basis of the absolute value θelt assigned to the measured absolute value θti and on the basis of the measured absolute value θelr; and
a mechanical angular absolute position Gabs of the rotating shaft within one rotation is calculated according to the following equation using a mechanical angle θelp that corresponds to an electrical angle of one period of an output signal of the multi-pole absolute-value encoder.
θabs=(Nr×θelp+θelr)/Pp

2. The method of detecting absolute rotational position according to claim 1, further comprising:
setting an angular reproducibility X of the two-pole absolute-value encoder so as to satisfy the equation X<2×{((θelp/M)−(Pp×θelp/Rt))/Pp}, where Rt is a resolution of the two-pole absolute-value encoder, and M is an integer of 2 or greater;
wherein, when θelt≧θelp/M, the pole-pair number Nr is set to Nx if θelr≧(θelt−θelp/M), and the pole-pair number Nr is set to Nx+1 if θelr<(θelt−θelp/M); and
wherein, when θelt<θelp/M, the pole-pair number Nr is set to Nx if θelr<(θelt+θelp/M), and the pole-pair number Nr is set to Nx−1 if θelr≧(θelt+θelp/M).

3. (canceled)

4. The method of detecting absolute rotational position according to claim 2, characterized in comprising setting the angular reproducibility X of the two-pole absolute-value encoder so as to satisfy the equation X<2×{((θelp/M)−(θelp/Rtmin))/Pp}, where Rtmin is a minimum value of the resolution of the two-pole absolute-value encoder for each of the magnetic pole pairs of the multi-pole absolute-value encoder.

5. A magnetic absolute-value encoder comprising the method of detecting absolute rotational position according to claim 1 to detect an absolute rotational position of a rotating shaft within one rotation.

6. A magnetic absolute-value encoder comprising the method of detecting absolute rotational position according to claim 2 to detect an absolute rotational position of a rotating shaft within one rotation.

7. A magnetic absolute-value encoder comprising the method of detecting absolute rotational position according to claim 4 to detect an absolute rotational position of a rotating shaft within one rotation.
